(19) United States
(12) Patent Application Publication
(10) Pub. No.: US 2009/0139852 A1
(43) Pub. Date: Jun. 4, 2009

(54) Separation Method And Apparatus

(76) Inventors: Marco L. VanNuland, Rijen (NL); Joseph M. Cheben, Houston, TX (US); Ronald L. DeMartino, Kingwood, TX (US); John R. Porter, Friendswood, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/950,147

(22) Filed: Dec. 4, 2007

(51) Int. Cl. B01D 3/14; B01D 3/34; B01D 3/42

(52) U.S. Cl. 203/49; 202/158; 202/160

(57) ABSTRACT

A process and an apparatus for the separation of a feed by distillation into a low-boiler (A), a medium-boiler (B) and a high-boiler fraction (C). Separation takes place in one or more dividing-wall columns, in which a dividing wall is arranged in the longitudinal direction of the column to thereby form an upper, common column region, a lower, common column region, a feed part with rectifying section and stripping section, and a withdrawal region with rectifying section and stripping section. The feed of the C5+ cut is in the central region of the feed part. The high-boiler fraction (C) is discharged from the bottom of the column, the low-boiler fraction (A) is discharged via the top of the column, and the medium-boiler fraction (B) is discharged from the central region of the withdrawal part. A first heat source is provided for heating the lower column region. A second heat source is provided for heating the withdrawal part whereby the fraction in the withdrawal part is heated to a temperature which is lower than the temperature of the fraction in the lower column region.

### FIELD

This invention relates to a separation method and a separation apparatus, particularly a method and an apparatus for distillative separation of a feed. The method and apparatus is particularly suited to separating feeds comprising a mixture of hydrocarbons having five or more carbon atoms per molecule (C5+ cuts).

### BACKGROUND

In refineries and petrochemical plants, hydrocarbon streams are produced and processed from crude oil based feeds. These streams are separated into various desired fractions or cuts by distillation. An important fraction, both in terms of volume and value is the C5+ cut. As this cut contains unsaturated compounds, this cut is generally hydrogenated to convert polyunsaturated compounds. The hydrogenated C5+ cut is usually processed to obtain aromatic compounds by a process which includes distillation.

Due to variations in the feed and processing conditions, the C5+ cut comprises a complex mixture of a multiplicity of components having small differences in their relative volatilities. Also, the C5+ cut is subject to variations in its composition. In known distillative processes for the separation of these cuts, a plurality of columns is necessary to obtain products having the desired purities.

For the separation of multi-component mixtures by distillation, so-called divided wall columns are known. These are distillation columns with vertical dividing walls which prevent cross-mixing of liquid and vapor streams in part-regions. The dividing wall divides the column in the longitudinal direction in its central region to form an upper, common column region, a lower, common column region, a feed part with a rectifying section and a stripping section, and a withdrawal region with a rectifying section and a stripping section. The feed is provided to the central region of the feed part. A high-boiler fraction is discharged from the bottom of the column, a low-boiler fraction is discharged from the top of the column, and a medium-boiler fraction is discharged from the central region of the withdrawal part to separate the feed to the dividing wall column into three separate cuts.

WO-A-02/24300 discloses such a divided wall column in which the dividing ratio of the liquid reflux at the upper end of the dividing wall is set in such a way that the proportion of high-boiling key components in the liquid reflux over the stripping section of the withdrawal part at the upper end of the dividing wall is from 10 to 80%, preferably from 30 to 50% of the limit value allowed in the medium boiler fraction. The heating power in the evaporator at the bottom of the dividing wall column is set in such a way that the concentration of the low-boiling key components in the liquid at the lower end of the dividing wall is from 10 to 80%, preferably from 30 to 50% of the limit value allowed in the medium-boiler fraction.

For distillation of many ternary mixtures, divided wall columns such as the divided wall column which is disclosed in WO-A-02/24300, are more energy efficient than a conventional distillation arrangement. The prefractionator (feed side of the divided wall) distills much of the medium boiling key component over the top of the wall and eliminates the remixing and redistillation inherent in a conventional distillation arrangement. In addition, the prefractionator section, the section between the overhead and sidestream and the section between the sidestream and the tower bottoms are all thermally integrated.

Although the overall energy requirement for a divided wall column is less than a conventional arrangement, the disadvantage of a divided wall column is that the energy which is supplied “heat input” must be adequate for the high-boiler fraction in the mixture to reach its bubble point at the bottom of the column. This means that the heat input must be of a relatively high temperature; and, as a significant amount of heat is required, this makes heat integration of a divided wall column in existing process installations difficult. In existing process installations, heat streams of a suitable power output and which are of a relatively high temperature are often not available. Divided wall columns are therefore often heated by their own allocated heat source which renders available waste heat streams unused.

The present invention seeks to overcome the aforedescribed problem and/or to provide improvements generally.

### SUMMARY OF THE INVENTION

According to the invention, there is provided a process and an apparatus as defined in any one of the accompanying claims.

In an embodiment, there is provided a process for the separation of a feed by distillation into a low-boiler (A), a medium-boiler (B) and a high-boiler fraction (C) in one or more dividing-wall columns, in which a dividing wall is arranged in the longitudinal direction of the column to form of an upper, common column region, a lower, common column region, a feed part with rectifying section and stripping section, and a withdrawal region with rectifying section and stripping section, the feed being in the central region of the feed part, the high-boiler fraction (C) being discharged from the bottom of the column, the low-boiler fraction (A) being discharged via the top of the column, and the medium-boiler fraction (B) being discharged from the central region of the withdrawal part, a first heat source being provided for heating the lower column region and a second heat source being provided for heating the withdrawal part. The fraction in the withdrawal part may be heated to a temperature which is lower than the temperature of the fraction in the lower column region.

By utilizing the second heat source, a substantial amount of the heat input can be of a lower temperature than the temperature which is required for the heat input using a single heat source in a conventional divided wall separation process. In a preferred embodiment, the second heat source heats the fraction in the withdrawal part to a temperature which is at or close to the bubble point of fraction B. The temperature is preferably within 20° C. of the bubble point, more preferably within 10° C. of the bubble point, even more preferably within 5° C. of the bubble point and most preferably within 1° C. of the bubble point of fraction B.

As a substantial amount of heat input is of a lower temperature than the temperature of the heat input from the first heat source, waste heat can be used from a large number of processes such as power generation, refrigeration, and other refinery processes. In this way there is provided a more energy efficient separation apparatus and process. Use of waste heat as a heat source also results in the separation apparatus and process having reduced capital costs in comparison to a conventional dividing wall separation process which requires its own heat source to supply the bulk of the required heat at a sufficiently high temperature.

In the context of the invention, the heat source is any source which is suitable for providing heat input to the low boiling and medium boiling fractions in the column. The heat input serves to increase the temperature of these fractions to allow these to be separated. The heat source may comprise an external source such as a waste heat source or a source connected with the process such as a boiler or heater.

In a preferred embodiment of the invention, the feed comprises a C5+ cut. In particular, the feed may solely consist of a C5+ cut or fraction. The C5+ cut of the feed denotes a mixture of hydrocarbons having five or more carbon atoms per molecule. The feed preferably comprises predominantly n-pentane, i-pentane, methylbutenes, cyclopentane, benzene, toluene, ethylbenzene and xylenes. The C5+ cuts may be hydrogenated. In any case, the process is not restricted to the type of feed and may be employed generally for the separation of C5+ cuts by distillation and the separation of other feeds.

The process of the invention is particularly suited to process C5+ cuts containing aromatics components, such as hydrogenated pyrolysis gasoline, but the process according to the invention is not restricted thereto, but instead can be employed generally for the separation of C5+ cuts by distillation.

The process of the invention facilitates optimum energy performance of the distillative separation while retaining good values for the specification of the middle boiling fraction, even for varying feed compositions of the C5+ cut.

In another embodiment of the invention, an additional feed is provided to the feed part. Depending on the anticipated boiling points of the components in the additional feed, the location in relation to the column may be selected such that the additional feed is located at the lower end or below the central region, in the central part of the central region or at the higher end or above the central region to facilitate the separation efficacy of the additional feed.

In a further embodiment, at least one additional fraction is discharged from the column. Depending on the location of discharge in relation to the column, fractions having the desired boiling point may be extracted in this way. Fractions having low boiling fractions may generally be discharged from the upper half of the column. Fractions having medium boiling fractions may be discharged from the central region of the column, whilst fractions having high boiling fractions may be discharged from the lower half of the column. In an embodiment, the additional fraction is discharged from a location at the column which differs from the location for discharging the low-boiling fraction (A), the medium-boiling fraction (B) and the high-boiling fraction (C).

In another embodiment of the invention, there is provided an apparatus for the separation of a feed by distillation into a low-boiler (A), a medium-boiler (B) and a high-boiler fraction (C), the apparatus comprising one or more dividing-wall columns, in which a dividing wall is arranged in the longitudinal direction of the column to thereby form an upper, common column region, a lower, common column region, a feed part with rectifying section and stripping section, and a withdrawal region with rectifying section and stripping section, the feed of the C5+ cut being in the central region of the feed part, the high-boiler fraction (C) being discharged from the bottom of the column, the low-boiler fraction (A) being discharged via the top of the column, and the medium-boiler fraction (B) being discharged from the central region of the withdrawal part, a first heat source being provided for heating the lower column region and a second heat source being provided for heating the withdrawal part. The fraction in the withdrawal part may be heated to a temperature which is lower than the temperature of the fraction in the lower column region.

According to another invention there is provided a process for the separation of a feed by distillation into at least a low-boiler (A), a medium-boiler (B) and a high-boiler fraction (C) in one or more dividing-wall columns (TK), in which a dividing wall (T) is arranged in the longitudinal direction of the column to form an upper, common column region, a lower, common column region, a feed part with rectifying section and stripping section, and a withdrawal region with rectifying section and stripping section, with at least one feed (A, B, C) into the central region of the feed part, discharge of the high-boiler fraction (C) from the bottom of the column, discharge of the low-boiler fraction (A) via the top of the column, and discharge of the medium-boiler fraction (B) from the central region of the withdrawal part, whereby the vapor flow at the bottom end of the dividing wall is controlled such that the ratio of the vapor stream in the feed part to the vapor stream in the withdrawal part is from 0.8 to 1.2.

In another embodiment to the invention, the ratio of the vapor stream in the feed part to the vapor stream in the withdrawal part is preferably from 0.9 to 1.1.

In a further embodiment, the return from the upper column part is regulated in such a way that the return stream in the feed part to the return in the withdrawal part is from 0.1 to 1.0, preferably from 0.3 to 0.6.

### BRIEF DESCRIPTION OF THE DRAWINGS

FIG. 1 presents a diagrammatic view of a process and apparatus comprising a divided wall column;

FIG. 2 presents a diagrammatic view of a process and apparatus according to an embodiment of the invention;

FIG. 3 presents a diagrammatic view of a process and apparatus according to another embodiment of the invention, and;

FIG. 4 presents a diagrammatic view of a process and apparatus according to another embodiment of the invention.

### DETAILED DESCRIPTION OF THE EMBODIMENTS

As discussed, dividing wall columns typically have a dividing wall aligned in the longitudinal direction of the column which divides the column interior into an upper, common column region, a lower, common column region, a feed part and a withdrawal part, each with a rectifying section and a stripping section. The mixture to be separated (A, B, C) is introduced into the central region of the feed part, a high-boiler fraction (C) is withdrawn from the bottom of the column, a low boiler fraction is withdrawn via the top of the column (A), and a medium boiler fraction (B) is withdrawn from the central region of the withdrawal part.

The feed or mixture to be separated may comprise a C5+ cut. Components which are critical for the separation problem are also known as so-called key components. In the process of the invention, for a C5+ cut, the key components for the medium boiling fraction may be cyclopentane, cyclopentene, hexane and hexene (low boiling components) and nonane (high boiling component) with the benzene/toluene/xylene taken off.

In the separation of multicomponent mixtures into a low boiler fraction (A), a medium boiler fraction (B) and a high boiler fraction (C), the maximum permissible content of the low boiling components (A) and high boiling components (C) in the medium boiler fraction (B) is usually specified in the medium boiler fraction as the limit value. In practice, the limit value is defined by the desired purity of the medium boiler fraction and the operating conditions of the column are controlled to achieve this.

In an embodiment, the first and second heat sources heat the respective column parts such that the concentration of the low-boiling components in the liquid at the lower end of the dividing wall is from 10 to 80% of the limit value allowed in the medium boiler fraction.

We have found that by regulating the dividing ratio of the liquid at the upper end of the dividing wall and the heating power of the heat sources, the dividing ratio of the liquid at the upper end of the dividing wall is set in such a way that the proportion of high boiling components in the liquid reflux over the stripping section of the withdrawal part is from 10% to 100%, preferably from 10% to 80%, more preferably from 30% to 50%, of the limit value allowed in the medium-boiler fraction.

In a further embodiment, the heating power in the evaporator at the bottom of the dividing wall column is set in such a way that the concentration of the low boiling key components in the liquid at the lower end of the dividing wall is from 10% to 100%, preferably from 10% to 80%, more preferably from 30% to 50%, of the limit value allowed in the medium boiler fraction. The liquid division at the upper end of the dividing wall may be controlled in such a way that for high amounts of high boiling fractions, more liquid is fed to the feed part, and in case of relatively low contents thereof, less liquid is fed to the feed part.

In another embodiment, control of the heat sources is such that in the case of a relatively high content of low boiling fraction, the heating power is increased, and in case of a low content of low boiling fraction, the heating power is reduced.

According to a further process variant, the withdrawal of the medium-boiler fraction takes place under level control, with the control quantity used being the liquid level in the bottom of the column. The bottom level is usually regulated via the bottom take-off. However, a conventional regulation of this type results in unsatisfactory control behavior in the present process. The preferred control concept claimed with regulation of the bottom level via the side take-off significantly improves the stability.

The divided wall column in the process of the invention is preferably operated at a pressure in the range from 0.05 to 0.5 MPa (0.5 to 5 bar), in particular from 0.1 to 0.2 MPa (1 to 2 bar).

Dividing-wall columns have from 20 to 100, preferably having from 25 to 45 theoretical separation stages.

The division of the number of separation stages into the individual part-regions of the dividing-wall column is preferably arranged such that each and every one of the column regions of the dividing-wall column has from 5 to 50%, preferably from 15 to 30% of the total number of theoretical separation stages of the dividing-wall column.

The division of the theoretical separation stages into the column sub-regions can preferably be carried out in such a way that the number of theoretical separation stages in the feed part is from 80 to 100%, preferably from 90 to 100%, of the total number of theoretical separation stages in the withdrawal part.

In a preferred embodiment, the feed point for the stream to be separated and the withdrawal point for the medium-boiler fraction can be arranged at different heights in the column, preferably separated by from 1 to 20, in particular by from 3 to 8, theoretical separation stages.

The column may include internals to facilitate separation. There are in principle no restrictions regarding the type or shape of the internals which can be employed in the dividing-wall column. Both packing elements and ordered packing or trays are suitable for this purpose. For cost reasons, trays are generally employed in columns having a diameter of greater than 1.2 m. In the case of packed columns, ordered sheet metal packing having a specific surface area of from 100 to 500 m²/m³, preferably from about 250 to 300 m²/m³, is particularly suitable.

In the case of particularly high demands regarding product purity, it is favorable, in particular for the case where packing is employed as separation active internals, to equip the dividing wall with thermal insulation. A dividing-wall design of this type is described, for example, in EP-A-0 640 367. A double-walled design with a narrow gas space in between is particularly favorable.

In a preferred embodiment, the columns comprise trays whose pressure loss increases constantly with increasing gas load, preferably by at least 10% per increase in the F factor by 0.5 Pa^{0.5}, are employed in the dividing-wall column. The F factor here (dimension: Pa^{0.5}) denotes in a known manner the gas loading in the form of the product of the gas velocity (in the dimension m/s) and the square root of the gas density (in the dimension kg/m³).

We will now disclose the invention by way of example only and with reference to the accompanying drawings in which:

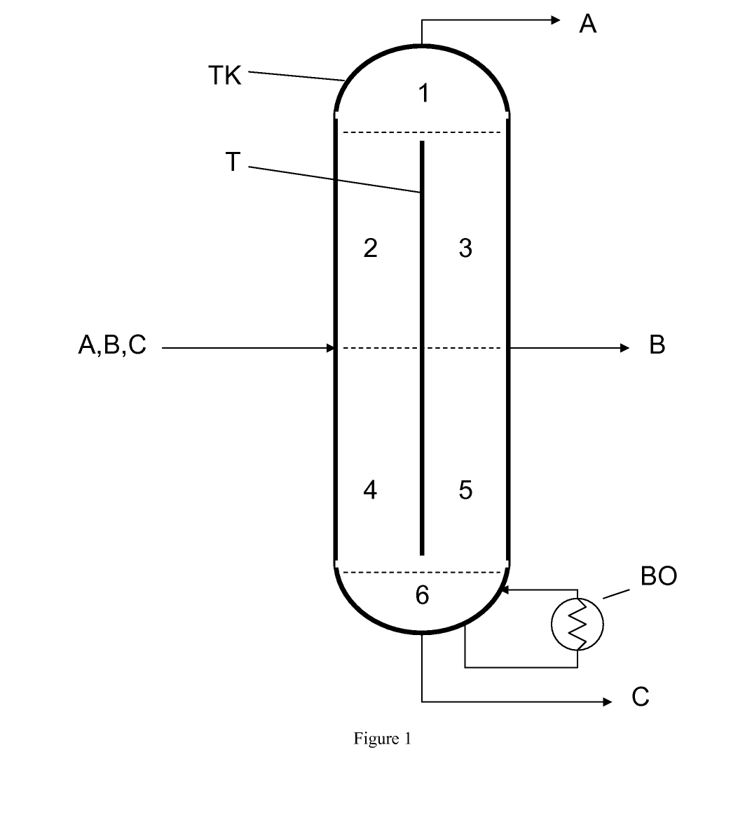

FIG. 1 shows a conventional dividing wall column (TK) with dividing wall (T) arranged vertically therein, dividing the column into an upper, common column region 1, a lower, common column region 6, a feed part 2, 4 with rectifying section 2 and stripping section 4 and a withdrawal part 3, 5 with stripping section 3 and rectifying section 5. The mixture to be separated (A, B, C) is fed into the central region of the feed part 2, 1. The low-boiler fraction (A) is discharged at the top of the column, the high-boiler fraction (C) is discharged from the bottom of the column, and the medium-boiler fraction (B) is discharged form the central region of the withdrawal part 3, 5. The column TK comprises a single reboiler (BO) which heats the fraction in the lower, common column region 6.

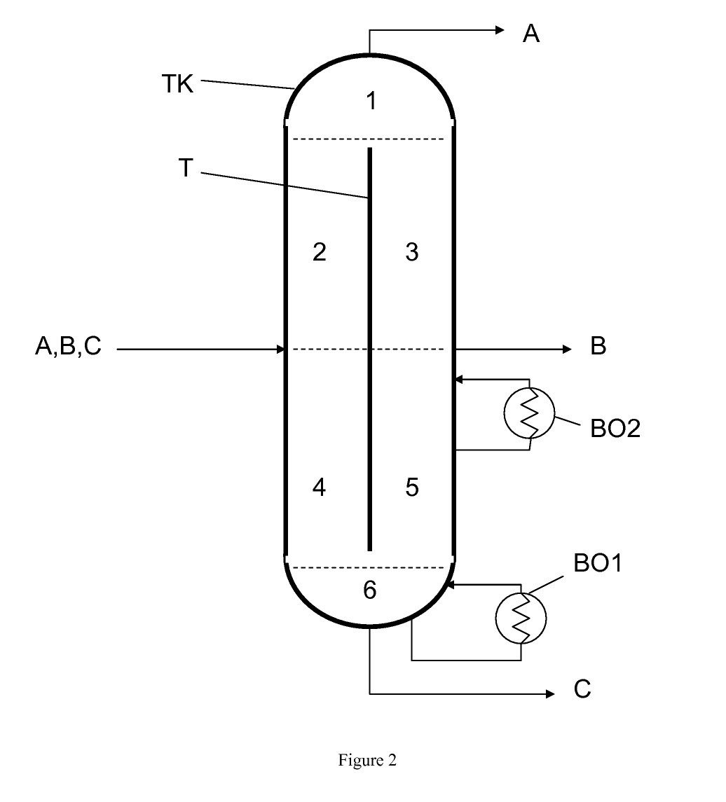

FIG. 2 shows a dividing wall column (TK) according to the invention. The same references have been used for the corresponding parts of the conventional dividing wall column of FIG. 1. The column TK comprises a first heat source in the form of reboiler (BO1) which heats the fraction in the lower, common column region 6. The column TK further comprises a second heat source in the form of a hip reboiler (BO2) which heats the fraction in the rectifying section.

The division of the liquid reflux is regulated at the upper and lower ends of the column. Preferably, as shown in FIG. 1, the withdrawal of the top-stream (A) and the withdrawal of the high-boiler stream (C) can take place under temperature control (TC). The medium-boiler fraction (3) is preferably withdrawn under level control, the control quantity used being the liquid level in the evaporator or at the bottom of the column. The heat input or heat power in the first and second heat sources is set in such a way that the concentration of the low-boiling components in the liquid at the lower end of the dividing wall is from 30 to 50% of the limit value allowed in the medium-boiler fraction.

We have assessed the impact of the hip reboiler of the column of the invention on the tray temperature and the total heat input in comparison with the column of FIG. 1 in which no secondary hear source is present. A feed comprising the composition as set out in the below Table 1 was led to the central region at a temperature of 138° C. and a pressure of 370.6 kPa g.

TABLE 1
Feed Composition
Feed Properties:

| Composition | wt % |
|---|---|
| BENZENE | 11.9794 |
| TOLUENE | 72.394 |
| 3MHEPTANE | 0.0136 |
| ETBENZENE | 0.581 |
| PARAXYLENE | 13.6211 |
| METAXYLENE | 0.5964 |
| ORTHOXYLENE | 0.0873 |
| 124TMBENZENE | 0.0169 |
| 1M4EBENZENE | 0.3047 |
| 14DMCH | 0.0187 |
| NAPHTHALENE | 0.2204 |
| Other impurities | 0.1665 |
| Flow Rate (kg/hr) | 253414.6 |
| Temperature | 138.03 |
| (deg C.) | |
| Pressure (kpa-g) | 370.588 |

The reboiler BO in FIG. 1 was set so that the total heat input Q was 42.3 MW at a temperature of 156.6° C. (Base case 1). In the process of the invention, the reboiler temperature was maintained at 156.6° C., but the heat input of reboiler BO1 was reduced, whilst additional heat was provided by the hip reboiler BO2 (cases 2 to 4). The below Table 2 sets out the experimental conditions for the comparative process 1 and processes 2 to 4 according to the invention.

In the processes according to the invention, the hip reboiler is located at different stages as indicated in Table 2. Table 2 further defines the temperature for the respective heat sources, the heat input and the total heat input into the divided wall column. The final column in Table 2 defines the percentage of additional heat input for the process of the invention.

As evidenced by Table 2, the heat input of the reboiler BO1 which is of a higher temperature than the heat input of the hip reboiler BO2; is reduced by approximately 50%, whereas the total heat input of a process according to the invention comprising two heat sources is only marginally increased by a maximum of 5.2%. This is achieved without compromising the separation efficiency and quality.

TABLE 2
Comparison of DWC FIG. 1 and FIG. 2

| | | | | | | | % |
|---|---|---|---|---|---|---|---|
| | | | | | | | Additional |
| Case | Hip | Reboiler | Hip stage | Hip Q | Reb Q | Total Q | Q vs |
| Number | stage # | Temperature | temperature | (MW) | (MW) | (MW) | Base |
| Base | Reboiler | 156.6 | NA | NA | 42.3 | 42.3 | |
| DWC | only | | | | | | |
| 1 | 55 | 156.6 | 138.9 | 25 | 18.1 | 43.1 | 1.9% |
| 2 | 53 | 156.6 | 135.4 | 25 | 18.8 | 43.8 | 3.4% |
| 3 | 51 | 156.6 | 133.3 | 25 | 20.3 | 45.3 | 7.1% |
| 4 | 50 | 156.6 | 132.6 | 25 | 21.6 | 46.6 | 10.2% |

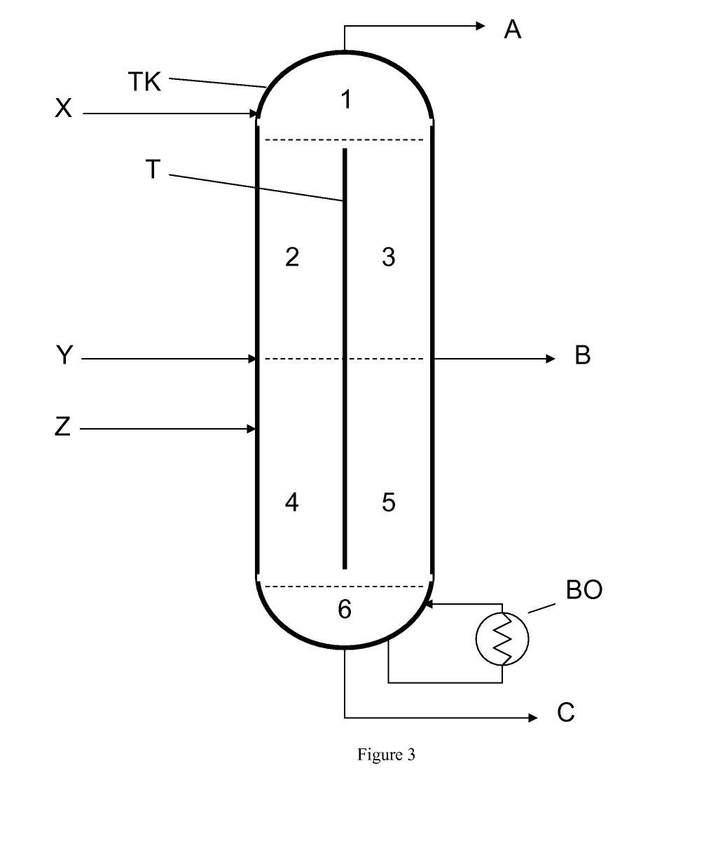

FIG. 3 shows a conventional dividing wall column (TK) with dividing wall (T) arranged vertically therein having multiple feeds X, Y and Z. The same references have been used for the corresponding parts of the conventional dividing wall column of FIG. 1. The mixture to be separated (A, B, C) is fed into the central region by feeds Y, Z and the upper common column region (1) by feed X. The low-boiler fraction (A) is discharged at the top of the column, the high-boiler fraction (C) is discharged from the bottom of the column, and the medium-boiler fraction (B) is discharged form the central region of the withdrawal part 3, 5. The column TK comprises a single reboiler (BO) which heats the fraction in the lower, common column region 6.

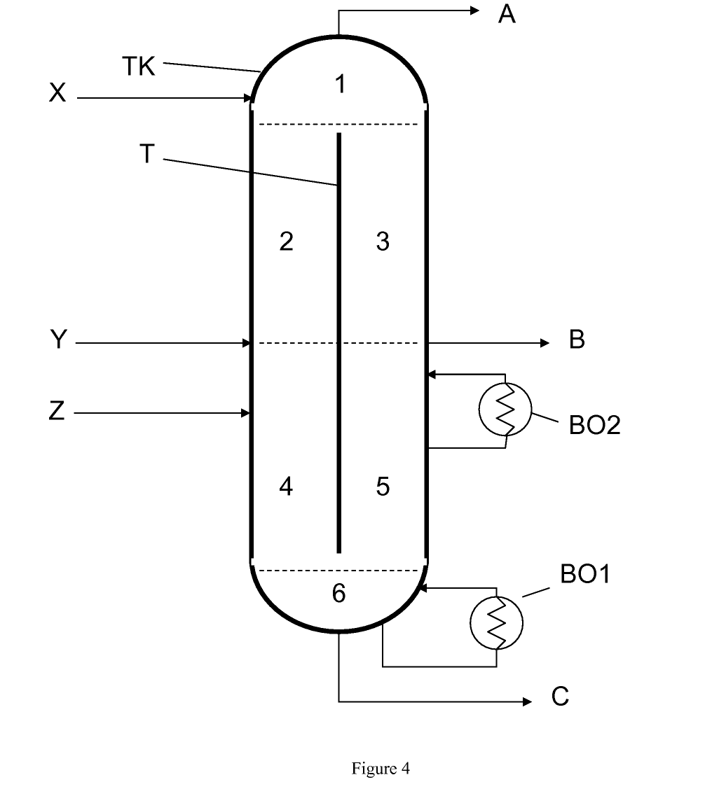

FIG. 4 shows a dividing wall column (TK) according to the invention having multiple feeds similar to the conventional column of FIG. 3. The same references have been used for the corresponding parts of the conventional dividing wall column of FIG. 3. The column TK comprises a first heat source in the form of reboiler (BO1) which heats the fraction in the lower, common column region 6. The column TK further comprises a second heat source in the form of a hip reboiler (BO2) which heats the fraction in the rectifying section.

The heat input or heat power in the first and second heat sources in FIG. 4 is set in such a way that the concentration of the low-boiling components in the liquid at the lower end of the dividing wall is from 30 to 50% of the limit value allowed in the medium-boiler fraction.

We have assessed the impact of the hip reboiler of the column of the invention of FIG. 4 on the tray temperature and the total heat input in comparison with the conventional column of FIG. 3. Feeds X, Y and Z comprising the composition as defined in the below Table 3 was led to the upper central region at a temperature of 117.9° C. (Feed X) and to the central region (Feeds Y and Z) at respective temperatures of 129.5° C. and 143.9° C. The pressure of Feed X was 262.3 kPa-a, the pressure of Feed Y was 155.0 kPa-a and the pressure of Feed Z was 326.0 kPa-a. The flow rates for the respective feeds are 83499.7 kg/hr (Feed X), 187018.7 kg/hr (Feed Y), 33211.5 kg/hr (Feed Z). The column pressure was held constant at 155 kPa-a throughout the column. The column was operated such that the concentration of toluene in the benzene product A was 100 ppm, and the toluene purity in the sidestream was 98.88%. The weight ratio of toluene to C8 aromatics in the bottoms product C was equal to 0.001.

TABLE 3
Feed Compositions

| | Feed | | |
|---|---|---|---|
| | X | Y | Z |
| BENZENE | 84.9270 | 0.1615 | 30.7991 |
| TOLUENE | 14.8168 | 83.5159 | 64.5698 |
| 3MHEPTANE | 0.0020 | 0.0128 | 0.0061 |
| Ethylbenzene | 0.0832 | 0.8729 | 1.4817 |
| PARAXYLENE | 0.0576 | 13.8276 | 1.1731 |
| METAXYLENE | 0.0806 | 0.9362 | 1.7590 |
| ORTHOXYLENE | 0.0057 | 0.1224 | 0.1998 |
| 124TMBENZENE | 0.0000 | 0.0127 | 0.0000 |
| 1M4EBENZENE | 0.0000 | 0.2384 | 0.0000 |
| 14DMCyclohexane | 0.0000 | 0.0218 | 0.0000 |
| NAPHTHALENE | 0.0000 | 0.1490 | 0.0000 |
| 2MNAPHTHALENE | 0.0000 | 0.0816 | 0.0000 |
| Other impurities | 0.0271 | 0.0472 | 0.0114 |
| Total | 100.0 | 100.0 | 100.0 |
| Flow Rate (KG/HR) | 83499.7 | 187018.7 | 33211.5 |
| Temperature (deg C.) | 117.9 | 129.5 | 143.9 |
| Pressure (kpa-a) | 262.3 | 155.0 | 326.0 |

The reboiler BO in FIG. 3 was set so that the total heat input Q was 24.9 MW at a temperature of 156.1° C. (Base case 1). In the process of the invention, the reboiler temperature was maintained at 156.1° C., but the heat input of reboiler BO1 was reduced, whilst additional heat was provided by the hip reboiler BO2 (cases 2 to 4). The below Table 4 sets out the experimental conditions for the comparative process 1 and processes 2 to 4 according to the invention.

In the processes according to the invention, the hip reboiler is located at different stages as indicated in Table 4. Table 4 further defines the temperature for the respective heat sources, the heat input and the total heat input into the divided wall column. The final column in Table 4 defines the percentage of additional heat input for the process of the invention.

As evidenced by Table 4, the heat input of the reboiler BO1 which is of a higher temperature than the heat input of the hip reboiler BO2; is reduced by approximately 50%, whereas the total heat input of a process according to the invention comprising two heat sources is only marginally increased by a maximum of 5.2%. This is achieved without compromising the separation efficiency and quality.

TABLE 4
Comparison of DWC FIG. 3 and FIG. 4

| | | | | | | | % |
|---|---|---|---|---|---|---|---|
| | | | | | | | Additional |
| Case | Hip | Reboiler | Hip stage | Hip Q | Reb Q | Total Q | Q vs |
| Number | stage # | Temperature | temperature | (MW) | (MW) | (MW) | Base |
| Base | Reboiler | 156.1 | NA | NA | 24.9 | 24.9 | |
| DWC | only | | | | | | |
| 1 | 55 | 156.1 | 137.7 | 14.5 | 10.5 | 25.0 | 0.4% |
| 2 | 53 | 156.1 | 134.6 | 14.5 | 10.7 | 25.2 | 1.2% |
| 3 | 51 | 156.1 | 133.0 | 14.5 | 11.1 | 25.6 | 2.8% |
| 4 | 50 | 156.1 | 132.4 | 14.5 | 11.7 | 26.2 | 5.2% |

There is thus provided a more energy efficient separation apparatus and process. By utilizing the second heat source, a substantial amount of the heat input can be of a lower temperature than the temperature which is required for the heat input using a single heat source in a conventional divided wall separation process. As a substantial amount of heat input is of a lower temperature than the temperature of the heat input from the first heat source, waste heat can be used from a large number of processes such as power generation, refrigeration, and other refinery processes. As more waste heat sources can now be applied to the process as a suitable heat source, the separation apparatus and process has reduced capital costs in comparison to a conventional dividing wall separation process which requires its own heat source to supply the bulk of the required heat at a sufficiently high temperature. The process and apparatus of the invention is particularly suited to the separation of C5+ cuts. However, other feeds, comprising alternative cuts may also be separated by means of the process and apparatus of the invention.

In another embodiment this invention relates to:

1. A process for the separation of a feed by distillation into at least a low-boiler (A), a medium-boiler (B) and a high-boiler fraction (C) in one or more dividing-wall columns (TK), in which a dividing wall (T) is arranged in the longitudinal direction of the column to form an upper, common column region (1), a lower, common column region (6), a feed part (2,4) with rectifying section (2) and stripping section (4), and a withdrawal region (3,5) with rectifying section (5) and stripping section (3); with at least one feed (A, B, C) into the central region of the feed part (2,4), discharge of the high-boiler fraction (C) from the bottom of the column, discharge of the low-boiler fraction (A) via the top of the column, and discharge of the medium-boiler fraction (B) from the central region of the withdrawal part (3,5), whereby a first heat source is provided for heating the lower column region and a second heat source is provided for heating the withdrawal part.
2. A process according to paragraph 1, whereby the fraction in the withdrawal part is heated to a temperature which is lower than the temperature of the fraction in the lower column region.
3. A process according to paragraph 1, whereby the fraction in the withdrawal part is heated to a temperature which is at or close to the bubble point of fraction B.
4. A process according to any of the preceding paragraphs, whereby the dividing ratio of the liquid reflux and low boiling fraction at the upper end of the dividing wall (T) is set in such a way that the proportion of high-boiling components in the liquid reflux over the stripping section (3) of the withdrawal part at the upper end of the dividing wall is from 10% to 100%, preferably from 10% to 80%, more preferably from 30% to 50% of the limit value allowed in the medium boiler fraction.
5. A process according to any of the preceding paragraphs, whereby the dividing ratio is set in such a way that the first and second heat sources heating the respective regions such that the concentration of the low-boiling components in the liquid at the lower end of the dividing wall is from 10% to 100%, preferably from 10% to 80%, more preferably from 30% to 50%, of the limit value allowed in the medium boiler fraction.
6. A process according to any of the preceding paragraphs, whereby the heat input of the respective boilers is less than the heat required to reach the bubble point of the high boiler fraction (C).
7. A process according to paragraphs 6, whereby the heat input of the respective boilers is less than the heat required to reach the bubble point of the medium-boiler fraction (B).
8. A process according to any of the preceding paragraphs, whereby the middle fraction is in the liquid phase.
9. A process according to any of the preceding paragraphs, whereby the vapor flow at the bottom end of the dividing wall is controlled such that the ratio of the vapor stream in the feed part to the vapor stream in the withdrawal part is from 0.8 to 1.2, preferably from 0.9 to 1.1, and in that the return from the upper column part is regulated in such a way that the return stream in the feed part to the return in the withdrawal part is from 0.1 to 1.0, preferably from 0.3 to 0.6.
10. A process according to any of the preceding paragraphs, whereby the feed point for the stream and the withdrawal point for the medium boiler fraction (B) are arranged at different heights in the column.
11. A process according to any of the preceding paragraphs, whereby at least one feed is provided to the feed part.
12. A process according to any of the preceding paragraphs, whereby at least an additional feed is provided to the upper, common column region (1) or the lower, common column region (6).
13. A process according to any of the preceding paragraphs, whereby an additional fraction is discharged from the column.
14. A process according to paragraph 13, whereby said additional fraction is discharged from a location at the column which differs from the location for discharging the low-boiling fraction (A), the medium-boiling fraction (B) and the high-boiling fraction (C).
15. A process for the separation of a feed by distillation into at least a low-boiler (A), a medium-boiler (B) and a high-boiler fraction (C) in one or more dividing-wall columns (TK), in which a dividing wall (T) is arranged in the longitudinal direction of the column to form an upper, common column region (1), a lower, common column region (6), a feed part (2,4) with rectifying section (2) and stripping section (4), and a withdrawal region (3,5) with rectifying section (5) and stripping section (3), with at least one feed (A, B, C) into the central region of the feed part (2,4), discharge of the high-boiler fraction (C) from the bottom of the column, discharge of the low-boiler fraction (A) via the top of the column, and discharge of the medium-boiler fraction (B) from the central region of the withdrawal part (3,5), whereby the vapor flow at the bottom end of the dividing wall is controlled such that the ratio of the vapor stream in the feed part to the vapor stream in the withdrawal part is from 0.8 to 1.2, preferably from 0.9 to 1.1.
16. A process according to any of the preceding paragraphs, whereby the feed comprises a C5+ cut.
17. An apparatus for the separation of a feed by distillation into a low-boiler (A), a medium-boiler (B) and a high-boiler fraction (C), the apparatus comprising one or more dividing-wall columns, in which a dividing wall is arranged in the longitudinal direction of the column to form an upper, common column region, a lower, common column region, a feed part with rectifying section and stripping section, and a withdrawal region with rectifying section and stripping section, the feed being located in the central region of the feed part, the high-boiler fraction (C) being discharged from the bottom of the column, the low-boiler fraction (A) being discharged via the top of the column, and the medium-boiler fraction (B) being discharged from the central region of the withdrawal part, the apparatus further comprising a first heat source for heating the lower column region and a second heat source for heating the withdrawal part.
18. An apparatus according to paragraph 17, whereby the fraction in the withdrawal part is heated to a temperature which is lower than the temperature of the fraction in the lower column region.
19. An apparatus according to paragraph 17 or 18, whereby the apparatus comprises a controller.
20. An apparatus according to paragraph 19, whereby the controller controls heating of the fraction in the withdrawal part to a temperature which is at or close to the bubble point of fraction B.
21. An apparatus according to paragraph 19, whereby the controller controls the dividing ratio of the liquid reflux and low boiling fraction at the upper end of the dividing wall (T) such that the proportion of high-boiling components in the liquid reflux over the stripping section (3) of the withdrawal part at the upper end of the dividing wall is from 10% to 100%, preferably from 10% to 80%, more preferably from 30% to 50% of the limit value allowed in the medium boiler fraction.
22. An apparatus according to paragraph 19, whereby the vapor flow at the bottom end of the dividing wall is controlled such that the ratio of the vapor stream in the feed part to the vapor stream in the withdrawal part is from 0.8 to 1.2, preferably from 0.9 to 1.1, and in that the return from the upper column part is regulated in such a way that the return stream in the feed part to the return in the withdrawal part is from 0.1 to 1.0, preferably from 0.3 to 0.6
23. An apparatus according to any of paragraphs 17 to 22, whereby the feed point for the stream and the withdrawal point for the medium boiler fraction (B) are located at different heights in the column.
24. An apparatus according to any of paragraphs 17 to 23, whereby the apparatus comprises at least one additional feed to the feed part.
25. An apparatus according to any of paragraphs 17 to 24, whereby the apparatus comprises at least an additional feed to the upper, common column region (1) or the lower, common column region (6).
26. An apparatus according to any of paragraphs 17 to 25, whereby an additional fraction is discharged from the column.
27. An apparatus according to paragraph 26, whereby said additional fraction is discharged from a location at the column which differs from the location for discharging the low-boiling fraction (A), the medium-boiling fraction (B) and the high-boiling fraction (C).
28. An apparatus according to any of paragraphs 17 to 27, whereby the feed comprises a C5+ cut.
29. Use of an apparatus according to any of paragraphs 17 to 28 in a process as defined in any of claims 1 to 16.
30. A low boiling fraction, a medium boiling fraction and a high boiling fraction obtained by a process as defined in any of paragraphs 1 to 16 and/or an apparatus as defined in any of paragraphs 17 to 29.

All documents described herein are incorporated by reference herein, including any priority documents and/or testing procedures to the extent they are not inconsistent with this text. While there have been described what are presently believed to be the preferred embodiments of the present invention, those skilled in the art will realize that other and further embodiments can be made without departing from the spirit of the invention, and is intended to include all such further modifications and changes as come within the true scope of the claims set forth herein.

What is claimed is:

1. A process for the separation of a feed by distillation into at least a low-boiler, a medium-boiler and a high-boiler fraction in one or more dividing-wall columns, in which a dividing wall is arranged in the longitudinal direction of the column to form an upper, common column region, a lower, common column region, a feed part with rectifying section and stripping section, and a withdrawal region with rectifying section and stripping section;
said process comprising:
providing at least one feed into the central region of the feed part;
discharging the high-boiler fraction from the bottom of the column, discharging the low-boiler fraction via the top of the column, and discharging the medium-boiler fraction from the central region of the withdrawal part; and
providing a first heat source for heating the lower column region and a second heat source for heating the withdrawal part.

2. A process according to claim 1, whereby the fraction in the withdrawal part is heated to a temperature which is lower than the temperature of the fraction in the lower column region.

3. A process according to claim 1, whereby the fraction in the withdrawal part is heated to a temperature which is at or close to the bubble point of fraction B.

4. A process according to claim 1, whereby the dividing ratio of the liquid reflux and low boiling fraction at the upper end of the dividing wall is set in such a way that the proportion of high-boiling components in the liquid reflux over the stripping section of the withdrawal part at the upper end of the dividing wall is from 10% to 100%, preferably from 10% to 80%, more preferably from 30% to 50% of the limit value allowed in the medium boiler fraction.

5. A process according to claim 1, whereby the dividing ratio is set in such a way that the first and second heat sources heating the respective regions such that the concentration of the low-boiling components in the liquid at the lower end of the dividing wall is from 10% to 100%, preferably from 10% to 80%, more preferably from 30% to 50%, of the limit value allowed in the medium boiler fraction.

6. A process according to claim 1, whereby the heat input of the respective boilers is less than the heat required to reach the bubble point of the high boiler fraction.

7. A process according to claim 6, whereby the heat input of the respective boilers is less than the heat required to reach the bubble point of the medium-boiler fraction.

8. A process according to claim 1, whereby the middle fraction is in the liquid phase.

9. A process according to claim 1, whereby the vapor flow at the bottom end of the dividing wall is controlled such that the ratio of the vapor stream in the feed part to the vapor stream in the withdrawal part is from 0.8 to 1.2, preferably from 0.9 to 1.1, and in that the return from the upper column part is regulated in such a way that the return stream in the feed part to the return in the withdrawal part is from 0.1 to 1.0, preferably from 0.3 to 0.6.

10. A process according to claim 1, whereby the feed point for the stream and the withdrawal point for the medium boiler fraction are arranged at different heights in the column.

11. A process according to claim 1, whereby at least one feed is provided to the feed part.

12. A process according to claim 1, whereby at least an additional feed is provided to the upper, common column region or the lower, common column region.

13. A process according to claim 1, whereby an additional fraction is discharged from the column.

14. A process according to claim 13, whereby said additional fraction is discharged from a location at the column which differs from the location for discharging the low-boiling fraction, the medium-boiling fraction and the high-boiling fraction.

15. A process for the separation of a feed by distillation into at least a low-boiler, a medium-boiler and a high-boiler fraction in one or more dividing-wall columns, in which a dividing wall is arranged in the longitudinal direction of the column to form an upper, common column region, a lower, common column region, a feed part with rectifying section and stripping section, and a withdrawal region with rectifying section and stripping section, with at least one feed comprising a C5+ cut into the central region of the feed part;
said process comprising;
discharging the high-boiler fraction from the bottom of the column, discharging the low-boiler fraction via the top of the column, and discharging the medium-boiler fraction from the central region of the withdrawal part, whereby the vapor flow at the bottom end of the dividing wall is controlled such that the ratio of the vapor stream in the feed part to the vapor stream in the withdrawal part is from 0.8 to 1.2, preferably from 0.9 to 1.1.

16. A process according to claim 1, whereby the feed comprises a C5+ cut.

17. An apparatus for the separation of a feed by distillation into a low-boiler, a medium-boiler and a high-boiler fraction, the apparatus comprising one or more dividing-wall columns, in which a dividing wall is arranged in the longitudinal direction of the column to form an upper, common column region, a lower, common column region, a feed part with rectifying section and stripping section, and a withdrawal region with rectifying section and stripping section; the feed being located in the central region of the feed part, the high-boiler fraction being discharged from the bottom of the column, the low-boiler fraction being discharged via the top of the column, and the medium-boiler fraction being discharged from the central region of the withdrawal part, the apparatus further comprising;
a first heat source for heating the lower column region and a second heat source for heating the withdrawal part.

18. An apparatus according to claim 17, whereby the fraction in the withdrawal part is heated to a temperature which is lower than the temperature of the fraction in the lower column region.

19. An apparatus according to claim 17, whereby the apparatus comprises a controller.

20. An apparatus according to claim 19, whereby the controller controls heating of the fraction in the withdrawal part to a temperature which is at or close to the bubble point of fraction B.

21. An apparatus according to claim 19, whereby the controller controls the dividing ratio of the liquid reflux and low boiling fraction at the upper end of the dividing wall such that the proportion of high-boiling components in the liquid reflux over the stripping section of the withdrawal part at the upper end of the dividing wall is from 10% to 100%, preferably from 10% to 80%, more preferably from 30% to 50% of the limit value allowed in the medium boiler fraction.

22. An apparatus according to claim 19, whereby the vapor flow at the bottom end of the dividing wall is controlled such that the ratio of the vapor stream in the feed part to the vapor stream in the withdrawal part is from 0.8 to 1.2, preferably from 0.9 to 1.1, and in that the return from the upper column part is regulated in such a way that the return stream in the feed part to the return in the withdrawal part is from 0.1 to 1.0, preferably from 0.3 to 0.6

23. An apparatus according to claim 17, whereby the feed point for the stream and the withdrawal point for the medium boiler fraction are located at different heights in the column.

24. An apparatus according to claim 17, whereby the apparatus comprises at least one additional feed to the feed part.

25. An apparatus according to claim 17, whereby the apparatus comprises at least an additional feed to the upper, common column region or the lower, common column region.
